(19) United States
(12) Patent Application Publication
(10) Pub. No.: US 2017/0297360 A1
(43) Pub. Date: Oct. 19, 2017

(54) METHOD FOR PRODUCING A DEVICE AND A SYSTEM COMPRISING SAID DEVICE, SUCH AS A CARD WITH A SCREEN, AND SYSTEM FOR PERSONALISING A TRADITIONAL SUPPORT COMPRISING A BUILT-IN VIDEO AND PHOTO DISPLAY

(71) Applicant: Pascal Gérard MILON, Cahaignes (FR)

(72) Inventor: Pascal Gérard MILON, Cahaignes (FR)

(21) Appl. No.: 15/516,353

(22) PCT Filed: Oct. 2, 2015
(86) PCT No.: PCT/EP2015/072826

§ 371 Date: Mar. 31, 2017

(30) Foreign Application Priority Data
Oct. 3, 2014 (FR) 1459513

(51) Int. Cl. B42D 15/02; B42D 15/04; G09F 1/04; G06F 1/16; G06F 3/147

(52) U.S. Cl. CPC B42D 15/022; G09F 1/04; G06F 1/1603; B42D 15/042; B42D 15/047; G06F 3/147

(57) ABSTRACT

A device is provided including a first sleeve for receiving a graphic medium, the first sleeve having a first window allowing the graphic medium to be viewed, and a second sleeve allowing an electronic appliance with a built-in electronic display to be received, the second sleeve including a second window allowing all of part of the electronic display to be viewed, the first and second sleeves being connected to each other. The first window allows the graphic medium to be viewed, which allows the personalization of the device.

### TECHNICAL FIELD

The invention relates to the field of built-in video and photo displays in traditional media such as cards, brochures, folders or also newspapers. More precisely, the invention relates to a device relating to video and photo displays and graphic media. The invention also relates to a method for producing such a device as well as a system comprising such a device. Finally, the invention also relates to the production of a card comprising such a system.

### STATE OF THE PRIOR ART

Devices having video displays built into a traditional medium such as a greetings card are known. The company Spreengs proposes such devices. However, the traditional medium cannot be personalized: a customer of this company can at most select a theme for the traditional medium, but cannot, for example, make a traditional medium comprising a photo that he took himself.

It is possible to have a personalized traditional medium comprising a built-in video display produced at a high price. The price is due to the specific format of this medium and to a high production cost for the manufacturer. For the purpose of clarity, producing a personalized traditional medium comprising a built-in video display is in the order of 200 euros.

A purpose of the invention is to propose a device comprising a personalized traditional medium and a video display at a lower price than the known devices, for example in the order of 50 euros. Another purpose of the invention is to propose a method for producing a device according to the invention.

### DISCLOSURE OF THE INVENTION

At least one of the abovementioned objectives can be achieved with a device comprising: a first sleeve capable of receiving a graphic medium, the first sleeve comprising a first window arranged in order to allow all or part of the graphic medium to be viewed, preferably opening onto the graphic medium, and a second sleeve capable of receiving an electronic appliance comprising an electronic display, the second sleeve comprising a second window arranged in order to allow all or part of the electronic display to be viewed, preferably opening onto the electronic display, the first and second sleeves being connected to each other.

Thus, the first window allows the graphic medium to be viewed, which allows the device to be personalized.

Advantageously, the device according to the invention can also comprise delimited areas arranged in order to transmit a command to the electronic appliance. Thus, the device according to the invention constitutes a means for controlling the electronic appliance. It is therefore not necessary to physically access the electronic appliance in order to control it. This results in straightforward use of the electronic appliance via the device according to the invention.

Preferably, the second window and the delimited areas are placed on a same face. Thus, a user of the device according to the invention can view the second window and the delimited areas at the same time.

Advantageously, the delimited areas can be placed on a face of the second sleeve.

According to a particular embodiment, the second sleeve can also be capable of receiving a connector of the electronic appliance and the second sleeve can also comprise an opening arranged in order to allow a connection of another electronic device to this connector, preferably in a position of the device according to the invention called closed position. Thus, it is not necessary to extract the electronic appliance from the second sleeve in order to connect another electronic device to this connector. This results in time saving and a straightforward connection to the electronic appliance.

Advantageously, the device according to the invention can be at least partially constituted by a single piece of material common to the two sleeves. This feature has the advantage of an increased production speed of the device according to the invention compared to the use of different materials, as well as a reduced production cost compared to the use of a plurality of materials. Preferably, the device according to the invention is integrally constituted by a single piece of material.

Preferably, the common piece of material is a piece of material in sheet form, in particular thick paper. A material in sheet form has the advantage of being foldable and inexpensive.

In a particular embodiment, the first sleeve can comprise protection means for the graphic medium, preferably a transparent sheet constituted by PVC. These protection means can also be arranged in order to prevent access to the graphic medium via the first window. Thus, the graphic medium is protected from external harm to the device according to the invention and consequently has a greater longevity.

Advantageously, the two sleeves can be connected by being joined to each other so that the first sleeve acts as a cover for the second sleeve, in particular for the window intended for the electronic display when the device is in a position called closed position. Thus, the first sleeve can also be arranged in order to protect the electronic display and the delimited areas when the device is in the closed position. Consequently, the electronic display and the delimited areas have a greater longevity.

In a particularly advantageous embodiment, the first sleeve can also comprise an opening arranged in order to allow the placement and the removal of the graphic medium from the first sleeve, preferably when the device according to the invention is in a position called closed position. The opening can be arranged in order to allow the placement and the removal of the graphic medium from the first sleeve when the device according to the invention is in the closed position. This feature has the advantage of allowing personalization of the device according to the invention without having to open the device. Consequently, the electronic display has a greater longevity.

According to a second aspect of the invention, a method for producing a device according to the invention by folding a material in sheet form is proposed. This method of production has the advantage of being quick and inexpensive.

According to a third aspect of the invention, a system comprising an electronic appliance including an electronic display and a device according to the invention is proposed.

Advantageously, the electronic appliance can also comprise a connector connected to the electronic display. This characteristic has the advantage of allowing interaction with the electronic display without removing it from the second sleeve, which leads to a time saving. Thus, the electronic display has a greater longevity.

Preferably, the electronic appliance comprises physical control means and the abovementioned delimited areas are placed facing these physical control means. Thus, there is no additional connection between the delimited areas and the physical control means, the pressure exerted by a finger on the sleeve at one of the delimited areas directly generating the desired command on the electronic appliance.

Advantageously, the system according to the invention can be intended to constitute a souvenir card, a greetings card, a post card an announcement or a scrapbook.

According to a fourth aspect of the invention, a method for constituting a card such as a souvenir card, greetings card, post card, announcement or scrapbook is proposed. The method of constituting such a card according to the invention comprises an electronic display of a system according to the invention. This electronic display can be loaded with personalized video, photo and sound content and the personalized graphic medium is placed in the first sleeve.

### DESCRIPTION OF THE FIGURES

Other advantages and characteristics of the invention will become apparent on reading of the detailed description of embodiments which is in no way limitative, with reference to the attached drawings, in which:

FIG. 1 is a perspective view of a device according to the invention in the semi-open state;

FIG. 2 schematically shows a panel for producing the device according to the invention;

FIG. 3 schematically shows the device according to the invention, seen from the front in the closed position; and

FIG. 4 schematically shows a part of the panel.

### DESCRIPTION OF THE EMBODIMENTS

As these embodiments are in no way limitative, variants of the invention can in particular be considered comprising only a selection of the characteristics described hereinafter, in isolation from the other characteristics described if this selection of characteristics is sufficient to confer a technical advantage or to differentiate the invention with respect to the state of the art.

A first embodiment of a device 1 according to the invention is now described. The device 1 comprises:
a first sleeve 2,
a second sleeve 3.

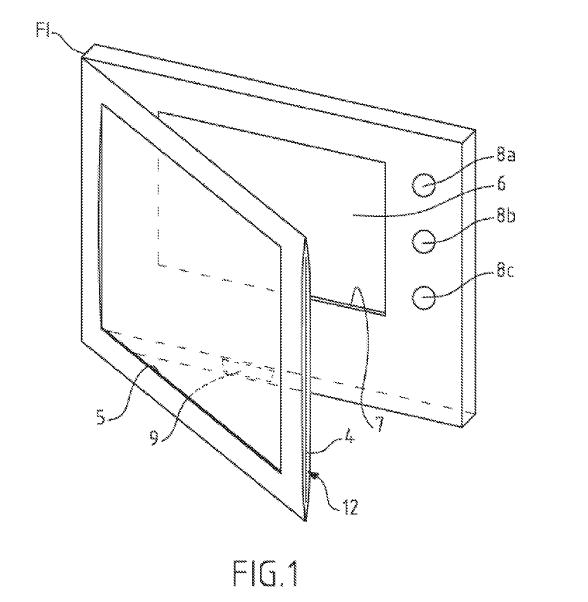

The first sleeve 2 and the second sleeve 3 are connected to each other. The device 1 is in a position called closed position when the first sleeve 2 is placed on the second sleeve 3. More precisely, and as is shown in FIG. 1, the two sleeves 2 and 3 are connected by being joined to each other along a common edge F1 between a closed position and an open position.

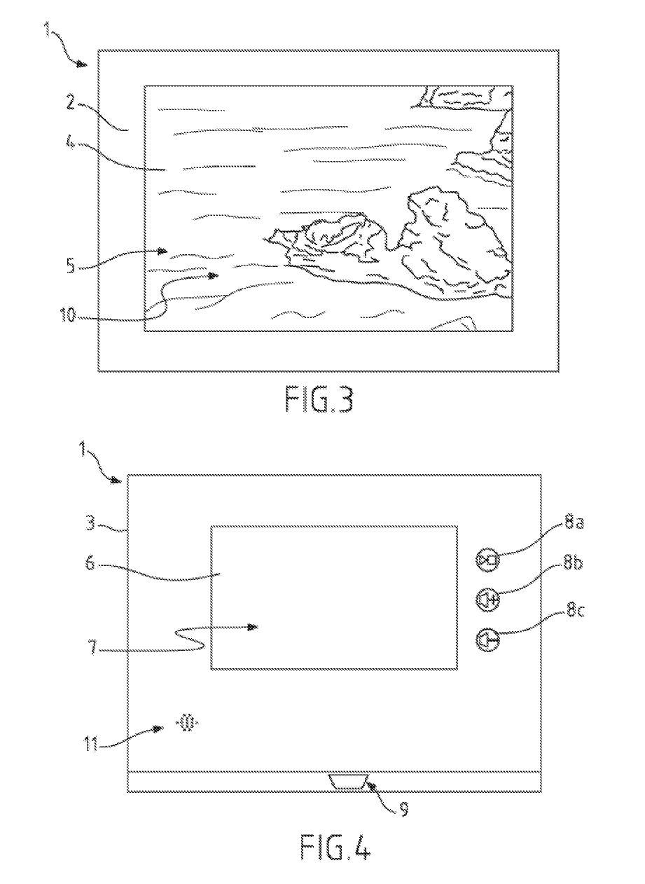

FIG. 3 shows a front view of the first sleeve 2 forming part of the device 1 according to the invention. The first sleeve 2 is capable of receiving, in a detachable manner, a graphic medium 4. The first sleeve 2 comprises a first window 5. The first window 5 opens onto a part of the graphic medium 4. The first window 5 is arranged in order to allow a part of the graphic medium 4 to be viewed.

The graphic medium 4 is a card which can be replaced with another card, photo, post card or illustration.

The first sleeve 2 is constituted by a flat pocket having, along an edge other than that of the join, an opening 12 allowing all of the graphic medium 4 to slide into the first sleeve 2 so that the image of the graphic medium 4 is visible through the first window 5. In the closed position, the first window 5 is turned from the side opposite to the second sleeve 3 so that the graphic medium 4 is visible when the device is closed. The outlines of the two sleeves are substantially identical so that they are superimposed in the closed position.

The opening 12 is arranged in order to allow the placement and the removal of the graphic medium 4 from the first sleeve 2 when the device 1 is in the closed position. This feature has the advantage of allowing personalization of the device 1 without having to open the device 1, which results in a greater longevity of the electronic display 6.

As shown in FIG. 1, the second sleeve 3 has a form of a flat box capable of receiving an electronic appliance.

The electronic appliance comprises an electronic display 6, a connector, a speaker, a memory and a processor as well as magnetized means.

A magnet (not shown) inserted in the first sleeve 2 cooperates with the magnetized means of the electronic device in order maintain a closed position. It can be moved to an open position by overcoming the magnetic force generated by the magnet of the first sleeve 2.

When the device 1 is manipulated in order to move from the closed position to the open position, the processor of the electronic appliance 1 starts a display by the electronic display 6 of media stored in the memory of the electronic appliance. When the device 1 is manipulated in order to move from the open position to the closed position, the processor of the electronic appliance stops the display of media by the electronic display 6.

The second sleeve 3 comprises a second window 7 opening onto the electronic display 6. The second window 7 is arranged in order to allow at least a part of the electronic display 6 to be viewed. The second window 7 is placed on a first face of the second sleeve 3.

Delimited areas 8a, 8b and 8c are also shown in FIGS. 1, 2 and 4. These delimited areas 8a, 8b and 8c are arranged in order to transmit a command to the electronic appliance. The delimited areas 8a, 8b and 8c and the second window 7 are placed on the same first face of the second sleeve 3. Thus, a user of the device 1 can view the second window 7 and the delimited areas 8a, 8b and 8c at the same time.

The delimited area 8a is arranged so that a first pressure on the delimited area 8a transmits a start command to the electronic appliance. The delimited area 8a is also arranged so that another pressure on the delimited area 8a transmits a pause command to the electronic appliance. The delimited area 8a is also arranged so that a prolonged pressure of a predetermined length of time, for example two seconds, on the delimited area 8a transmits a command to move to another medium when at least two media are stored in the memory of the electronic appliance.

The delimited area 8b is arranged so that a pressure on the delimited area 8b transmits a command to the electronic appliance to increase the sound volume.

The delimited area 8c is arranged so that a pressure on the delimited area 8c transmits a command to the electronic appliance to reduce the sound volume.

Thus, the device 1 constitutes a means for controlling the electronic appliance. It is not necessary to physically access the electronic appliance in order to control it. This results in straightforward use of the electronic appliance via the device 1.

The second sleeve 3 also comprises an opening 9 (FIG. 4) arranged on a second face of the panel, the opening 9 being intended to be located facing a connector for the electronic appliance. The opening 9 allows connection of another electronic device to the connector of the electronic appliance. Thus, it is not necessary to extract the electronic appliance from the second sleeve 3 in order to connect an external electronic device. This results in time saving and straightforward connection to the electronic appliance.

The second sleeve 3 also comprises another opening 11, arranged on the first face of the second sleeve 3. In the example shown, the other opening 11 is constituted by approximately ten microperforations, for example placed in a circle of a diameter of approximately 2 centimetres. The opening 11 allows sound to leave the second sleeve 3 cleanly without resonance. The electronic appliance is captive within the second sleeve 3 which is closed along all its sides in a manner sufficient for this purpose.

The device 1 according to the invention is at least partially constituted by a single piece of material common to the first sleeve 2 and the second sleeve 3. This feature has the advantage of an increased production speed compared to the use of different materials, as well as a reduced production cost compared to the use of a plurality of materials.

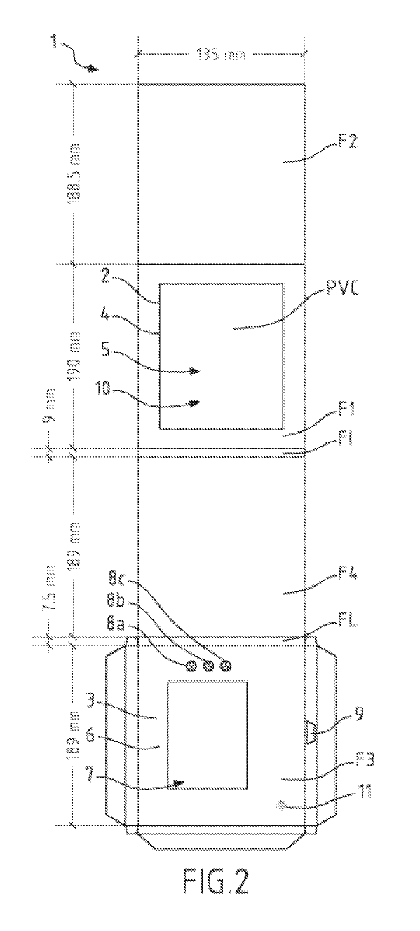

The common piece of material is a piece of material in sheet form, in particular thick paper, obtained by cutting (FIG. 2). A material in sheet form has the advantage of being foldable and inexpensive.

The first sleeve 2 comprises protection means 10 for the graphic medium 4. These protection means 10 preferably comprise a sheet constituted by transparent PVC (polyvinyl chloride). These protection means are arranged in order to prevent access to the graphic medium 4 via the first window 5. Thus, the graphic medium 4 is protected from external harm to the device 1 and consequently has a greater longevity.

The first sleeve 2 is also arranged in order to protect the electronic display 6 and the delimited areas 8a, 8b and 8c when the device 1 is in the closed position. Consequently, the electronic display 6 and the delimited areas 8a, 8b and 8c have a greater longevity.

In a second embodiment, only described for its differences with the first embodiment, the device 1 according to the invention is entirely constituted by a single piece of material common to the two sleeves. This feature has the advantage of an increased production speed compared to the use of different materials, as well as a reduced production cost compared to the use of different materials. In this embodiment, the windows are not furnished with transparent material.

FIG. 2 shows a panel of a device 1 according to the first embodiment of the invention, i.e. the blank of thick paper allowing the device 1 to be made by folding and bonding.

In FIG. 2, different elements already described and shown in FIGS. 1, 3 and 4 are shown.

The first sleeve 2 and the second sleeve 3 are connected by the rectangular lateral face F1 with dimensions 9 mm by 135 mm.

The first sleeve 2 comprises a rectangular first face F1 with dimensions 190 millimetres by 135 millimetres. The first face F1 comprises the first window 5 arranged in order to allow a part of the graphic medium 4 to be viewed. The protection means 10 for the graphic medium 4 comprising a sheet constituted by PVC are inserted between the graphic medium 4 and the first face of the first sleeve 2. The first sleeve 2 also comprises a rectangular second face F2 with dimensions 188.5 millimetres by 135 millimetres.

The second sleeve 3 comprises a rectangular first face F3 with dimensions 189 millimetres by 135 millimetres. The first face F3 comprises the second window 7 arranged in order to allow a part of the electronic display 6 to be viewed.

The second sleeve 3 also comprises the opening 9 allowing a connection of another electronic device to the electronic appliance.

The second sleeve 3 also comprises a rectangular second face F4 with dimensions 189 millimetres by 135 millimetres. The two faces F3 and F4 are connected by a lateral face FL with dimensions 7.5 millimetres by 135 millimetres.

A method for constituting a card with a screen such as a post card, souvenir card, greetings card, announcement or scrapbook is also proposed. In the method according to the invention, the electronic display of the system according to the invention can be loaded with personalized video content and the personalized graphic medium can be placed in the first sleeve. It is then possible to modify the video content using the connector connected to the electronic display and/or to personalize the graphic medium by removing it and replacing it with another.

Of course, the invention is not limited to the examples which have just been described and numerous adjustments can be made to these examples without exceeding the scope of the invention. The electronic appliance can for example be a USB drive equipped with a screen in order to display content stored in its memory. Moreover, the different characteristics, forms, variants and embodiments of the invention can be combined together in various combinations if they are not incompatible or mutually exclusive.

1. A device comprising:
a first sleeve capable of receiving a graphic medium, said first sleeve comprising a first window arranged in order to allow all or part of said graphic medium to be viewed; and
a second sleeve capable of receiving an electronic appliance comprising an electronic display, said second sleeve comprising a second window arranged in order to allow all or part of said electronic display to be viewed; and
said first and second sleeves being connected to each other.

2. The device according to claim 1, characterized in that it comprises delimited areas arranged in order to transmit a command to the electronic appliance.

3. The device according to claim 2, characterized in that the delimited areas are placed on a face of the second sleeve.

4. The device according to claim 1, characterized in that the second sleeve is also capable of receiving a connector of the electronic appliance and in that said second sleeve also comprises an opening arranged in order to allow connection of another electronic device to said connector, preferably in a position of the device called closed position.

5. The device according to claim 1, characterized in that it is at least partially constituted by a single piece of material common to the two sleeves.

6. The device according to claim 5, characterized in that the common piece of material is a piece of material in sheet form, in particular thick paper.

7. The device according to claim 1, characterized in that the first sleeve comprises protection means for the graphic medium, preferably a transparent sheet constituted by PVC.

8. The device according to claim 1, characterized in that the two sleeves are connected by being joined to each other so that the first sleeve acts as a cover for the electronic display when the device is in a position called closed position.

9. The device according to claim 1, characterized in that the first sleeve also comprises an opening arranged in order to allow the placement and the removal of the graphic medium from said first sleeve, preferably when said device is in a position called closed position.

10. A method for producing a device according to claim 1 by folding a material in sheet form.

11. A system comprising:
an electronic appliance including an electronic display,
a device according to claim 1.

12. The system according to claim 11, characterized in that the electronic appliance also comprises a connector connected to said electronic display.

13. The system according to claim 11, when dependent on claim 2, characterized in that the electronic appliance comprises physical control means and in that the delimited areas are placed facing these physical control means.

14. The system according to claim 11, characterized in that it is intended to constitute a souvenir card, a greetings card, a post card, an announcement or a scrapbook.

15. A method for constituting a card such as a post card, souvenir card, greetings card, announcement or scrapbook according to the system of claim 14.
